(19) United States
(12) Patent Application Publication
(10) Pub. No.: US 2021/0188673 A1
(43) Pub. Date: Jun. 24, 2021

(54) Process and installation for treating a waste lye of a lye scrub

(71) Applicant: LINDE GmbH, Pullach (DE)

(72) Inventors: Anton WELLENHOFER, Hohenschäftlarn (DE); Jörg ZANDER, München (DE); Ekaterina ANANIEVA, München (DE); Florian HAIRER, München (DE); Michael ROTHE, München (DE); Martin SCHUBERT, München (DE)

(21) Appl. No.: 17/051,140

(22) PCT Filed: Apr. 26, 2019
(86) PCT No.: PCT/EP2019/060806

§ 371 Date: Oct. 27, 2020

(30) Foreign Application Priority Data
Apr. 27, 2018 (DE) 10 2018 110 299.2
Jun. 19, 2018 (EP) 18178634.4

(51) Int. Cl. C02F 1/72; C02F 1/20; C02F 1/22

(52) U.S. Cl. CPC C02F 1/727; C02F 1/20; C02F 2103/18; C02F 2201/005; C02F 1/22

(57) ABSTRACT

The invention relates to a process for treating a waste lye of a lye scrub in which the waste lye is fed with oxygen or an oxygen-containing gas mixture and steam to an oxidation unit (1) and in the latter is subjected to a wet oxidation for a reaction time period at a first temperature level and a first pressure level, a three-phase component mixture, which comprises a gas phase, a liquid phase and solid particles, being removed from the oxidation unit (1) and subjected to a cooling and phase separation. It is provided that the three-phase component mixture in an unchanged composition is first subjected to an expansion from the first pressure level to a second pressure level and thereby cooled down to a second temperature level, and that the three-phase component mixture expanded to the second pressure level and cooled down to the second temperature level is subsequently subjected at least partly to a further cooling to a third temperature level and after that to a phase separation. A corresponding installation is likewise the subject of the present invention.

The invention relates to a process for treating a waste lye of a lye scrub using an oxidation reactor and to a corresponding installation according to the respective preambles of the independent patent claims.

### PRIOR ART

Olefins such as ethylene or propylene, but also diolefins such as butadiene and aromatics can be produced from paraffin by steam cracking. Corresponding processes have long been known. For details, also see the specialist literature such as the article “Ethylene” in Ullmann's Encyclopedia of Industrial Chemistry, online edition, 15 Apr. 2007, DOI 10.1002/14356007.a10_045.pub2.

Steam cracking produces so-called cracked gas, which along with the target products contains unconverted hydrocarbons and undesired byproducts. In known processes, this cracked gas is first subjected to a processing treatment before it is passed on to a fractionation to obtain various hydrocarbons or hydrocarbon fractions. Details are described in the cited article, in particular in section 5.3.2.1, “Front-End Section” and 5.3.2.2., “Hydrocarbon Fractionation Section”.

A corresponding processing treatment comprises in particular a so-called acid gas removal, in which components such as carbon dioxide, hydrogen sulfide and mercaptans are separated from the cracked gas. The cracked gas is typically compressed before and after a corresponding treatment. For example, the cracked gas may be removed from a so-called raw gas compressor at an intermediate pressure level, subjected to the acid gas removal, and subsequently compressed further in the raw gas compressor.

The acid gas removal may comprise in particular a so-called lye scrub using caustic soda solution. In particular when there are high concentrations of sulfur compounds, the lye scrub may also be combined with an amine scrub, for example by using ethanol amine. The waste lye obtained in the lye scrub, which contains several percent of sulfide and carbonate, is typically oxidized, and possibly neutralized, in a waste lye treatment before it can be subjected to a biological wastewater treatment. The oxidation serves for removing toxic components and for reducing the biological oxygen demand. The waste lye oxidation is typically carried out in the form of a chemical wet oxidation of the sulfide with oxygen in solution.

A number of different processes for wet oxidation of spent waste lyes are known from the prior art. For example, reference may be made to the article by C. B. Maugans and C. Alice, “Wet Air Oxidation: A Review of Commercial Sub-critical Hydrothermal Treatment”, IT3'02 Conference, 13 to 17 May 2002, New Orleans, La., or U.S. Pat. No. 5,082,571 A.

In such processes, the spent waste lye may be brought to the desired reaction pressure and heated up in counter current with the oxidized waste lye. The heated spent waste lye may subsequently be introduced into an oxidation reactor while supplying oxygen and be oxidized. The oxygen required for the reaction is in this case added either in the form of air or as pure oxygen. An additional heating of the spent waste lye, which in other variants of the process may also be the only heating, may be performed by introducing hot steam into the oxidation reactor.

After a typical residence time of about one hour (depending on the temperature chosen and the pressure chosen), the oxidized waste lye with the associated waste gas is cooled down by means of a heat exchanger while heating the spent waste lye. After checking the pressure, the waste gas is separated from the liquid in a subsequent separating vessel. After that, the liquid oxidized waste lye may be introduced into a process for biological wastewater treatment, while optionally setting the pH (neutralization).

Further processes and process variants are described in DE 10 2006 030 855 A1, U.S. Pat. No. 4,350,599 A and the article by C. E. Ellis, “Wet Air Oxidation of Refinery Spent Caustic”, Environmental Progress, volume 17, no. 1, 1998, pages 28-30.

The oxidation of the sulfur-containing compounds in the spent waste lye normally takes place in two different steps. During the oxidation of sulfides, sulfite, sulfate and thiosulfate are produced in parallel. While sulfite very quickly oxidizes further to form sulfate, the further reaction of thiosulfate is comparatively slow. The main reactions involved here are as follows:

2Na₂S+2O₂+H₂O⇄Na₂S₂O₃+2NaOH (1)

Na₂S₂O₃+2NaOH⇄2Na₂SO₄+H₂O (2)

Prior art for waste lye oxidation are an operating pressure of 6 to 40 bar and an operating temperature of up to above 200° C., for example up to 210° C. The higher the temperature in the reactor is chosen, the higher the pressure must be set, since the vapour pressure increases greatly with the temperature. The residence time in the reactor that is required for an extensive conversion falls from around the order of 12 hours at 6 bar to 10% of that residence time at 30 bar.

According to the prior art, the waste lye is fed into the oxidation reactor. An oxygen carrier, generally air, is mixed with the lye at any point desired, usually upstream of the actual reactor. The waste lye or the mixture of waste lye and oxygen carrier may be preheated in a heat exchanger.

According to the prior art, therefore, when it is fed into the oxidation reactor, the waste lye may be preheated. However, this is not absolutely necessary. Further heating (or the only heating) is often performed by means of adding steam, which may take place either into the incoming waste lye or directly into the reactor, and generally also by the reaction enthalpy or exothermicity of the oxidation reactions. As mentioned, in corresponding processes a preheating of the waste lye to the reactor may also be carried out as compared with the product from the reactor.

Since the pressure of the gas phase comprising the vapour pressure and the pressure of the oxidation air are added and the pressure of the inflowing steam must be at least as great as the reactor pressure, superheated steam especially comes into consideration for the adding of steam mentioned. This partially condenses, and in this way provides the additional heat.

According to the prior art, an oxidation reactor used for the waste lye oxidation is constructed in such a way that a directed flow forms in the reactor and, as a result, a greater reaction rate and a higher conversion are possible. For this purpose, internal fittings in the form of perforated trays may be used.

Processes of the aforementioned type are known for example from DE 10 2010 049 445 A1, in which a pressure of more than 60 bar is used in a corresponding reaction reactor, and from DE 10 2006 030 855 A1.

Because of the extreme loads, reactors for waste lye oxidation are produced from high-grade materials such as nickel-based alloys or nickel. However, even such materials can be attacked by high sulfate concentrations at elevated temperatures.

In particular, the treatment of a component mixture leaving or removed from a corresponding oxidation reactor proves to be a complex undertaking if conventional processes are used, and devices that are conventionally used for this are unsatisfactory for the reasons explained below. The present invention therefore addresses the problem of providing improved measures for treating corresponding component mixtures. A corresponding installation is intended in particular to provide a comparable service life for corresponding components of the installation with less expenditure on material or to provide an increased service life with the same expenditure on material.

### DISCLOSURE OF THE INVENTION

Against this background, the present invention proposes a process for treating a waste lye of a lye scrub by using an oxidation reactor and a corresponding installation according to the respective preambles of the independent patent claims. Configurations of the present invention are respectively the subject of the dependent patent claims and of the following description.

### ADVANTAGES OF THE INVENTION

A component mixture leaving an oxidation reactor of the type explained is typically three-phase and comprises gas, aqueous liquid (lye) and solids in the form of organic components (oligomers, polymers) and inorganic components (salts).

According to the prior art, this three-phase component mixture is cooled at the outlet of the oxidation reactor in one or more heat exchangers, the components that can still be condensed being condensed out. The gas phase and the liquid phase and the solid phase are already separated from one another in a corresponding heat exchanger or in a vessel downstream thereof. The correspondingly separated and cooled media are respectively passed separately via valves, expanded to almost ambient pressure and passed on for a further aftertreatment.

In the explained treatment of the three-phase component mixture removed from the oxidation reactor, it is disadvantageous in particular that the heat exchanger used comes into contact with hot reaction products. Even when high-grade materials such as Alloy 600 or nickel are used, the lifetime of the corresponding heat exchanger is low due to the aggressivity of the media (lye and abrasively acting solids) and constantly changing wetting surfaces, and is in any event restricted to well below 20 years. It should be noted here that, when using the process variants described at the beginning, a corresponding heat exchanger must withstand a high operating pressure of 20 to 40 bar, and therefore corresponding material strengths are required.

Another disadvantage is that the separated liquid phase with particles contained therein is expanded at process pressure and residual gases dissolved in the liquid are thereby outgassed (“flashing”). As a result, the valve used for the expansion is flowed through once again by a three-phase mixture, the degassing causing extremely high flow rates. Due to the particles present, strong mechanical or abrasive loads thereby occur. Downstream of a corresponding valve, the residual gas forming generally has to be separated once again from the liquid and discharged separately from it, for example together with the gas phase already separated off upstream.

Due to the solids content of the liquid expanded in the valve and the small seats of the liquid (control) valves used in comparison with gas (control) valves, these valves, which are typically designed as nozzle valves, tend to block and leak owing to the particles mentioned in the form of the polymers and salts.

These disadvantages can be overcome by using the measures proposed within the context of the present invention. In particular, there is a significant increase in the service life of a heat exchanger used and an aftertreatment or storage of the liquid is made easier as a result of a low content of outgassing components. Altogether, the availability of a corresponding process or a corresponding installation is increased by the use of the present invention.

Altogether, the present invention proposes a process for treating a waste lye of a lye scrub of the previously explained type in which the waste lye is fed with oxygen or an oxygen-containing gas mixture to an oxidation unit and in the latter is subjected to a wet oxidation for a reaction time period at a first temperature level and a first pressure level. The oxidation unit may in particular comprise one or more of the previously explained oxidation reactors and also apparatuses assigned to them, or heating devices, steam systems and the like. The wet oxidation in the oxidation unit is carried out as previously explained in detail.

As likewise mentioned, thereby, and consequently also within the context of the present invention, a three-phase component mixture, which comprises a gas phase, a liquid phase and solid particles, is removed from the oxidation unit and subjected to a cooling and phase separation. As also explained once again with reference to the appended FIG. 1, this conventionally takes place in the previously mentioned way, to be specific in such a way that a corresponding three-phase component mixture is first subjected without expansion to a cooling and subsequently to a phase separation. An expansion of the phases formed subsequently takes place. The previously explained problems, which take the form in particular of great mechanical loading of the expansion valves used in a corresponding expansion, may occur here.

To overcome the problems explained, by contrast the present invention proposes first subjecting at least part of the three-phase component mixture in an unchanged composition to an expansion from the first pressure level to a second pressure level and thereby cooling it down to a second temperature level. To avoid any lack of clarity, it should be emphasized that the “unchanged composition” relates in particular to the respective contents of the gaseous, liquid and solid phases upstream of the expansion. Downstream of the expansion, it may be that there is a relative increase in the gas phase and reduction in the liquid phase, in particular due to outgassing. The “unchanged composition” does not exclude the possibility that a fraction with a likewise unchanged composition is discharged upstream of the expansion and only the remaining fraction with unchanged composition is passed on to the expansion.

Within the context of the present invention, such an expansion has proven to be particularly advantageous. Within the context of the present invention, it exploits the fact that the temperature of a corresponding three-phase component mixture, which contains outgassing components, is reduced for example from a temperature level around about 200° C. to a temperature level of well below 170° C. when it is expanded from the pressure level typically used in a corresponding reactor of 30 to 40 bar to a pressure level of 1 to 10 bar (absolute pressures in each case). A temperature level occurring during expansion to 7 bar lies for example at about 150° C. This advantageous physical behaviour of the expanded medium, i.e. of the three-phase component mixture, is exploited within the context of the present invention.

Within the context of the present invention, furthermore, the three-phase component mixture expanded to the second pressure level and cooled down to the second temperature level is subsequently subjected at least partly to a further cooling to a third temperature level and after that to a phase separation. This further cooling may take place in particular in one or more heat exchangers, which however are loaded to a lesser extent because of the cooling and expansion that has already taken place before and also because of further advantages that are achieved within the context of the present invention, and therefore can be produced at lower cost or, if the same materials as before are used, have a longer service life. In the subsequent phase separation, there is less outgassing because of the significant pressure reduction already performed, and this makes it possible to dispense with a renewed phase separation. The process proposed according to the invention therefore manages with a smaller number of apparatuses, control devices and the like, which within the context of the present invention can moreover be produced at lower cost.

In particular, within context of the present invention there is a fall in the peak temperature at the heat exchanger used for the cooling from the second temperature level to the third temperature level or in a number of corresponding heat exchangers. As a result, the use of less expensive materials (for example austenitic high-grade steel or comparable) is possible, with a reduced service life. As an alternative to that, when corresponding high-grade materials are used within the context of the present invention, such as Alloy 600 or nickel-based alloys or nickel, a significant increase in the heat exchanger service life can be achieved, which in this way can be in the range of a typical installation service life. Therefore, if the process proposed according to the invention is used, corresponding heat exchangers do not need to be replaced prematurely.

Furthermore, the expansion from the first pressure level to the second pressure level means that a corresponding heat exchanger is subjected to the loading of a lower pressure. The same also applies correspondingly to the supply lines and further apparatuses that carry the three-phase component mixture. The lower operating pressure means that the required wall thickness of the pipes involved and the entire heat exchanger is less. In this way, the thermal mass and the inertia are reduced. Moreover, lower material costs are also obtained in this area by use of the present invention.

Another advantage that is achieved by the process according to the invention is that the heat exchanger or exchangers that is or are used for the cooling from the second temperature level to the third temperature level is or are flowed through with a smaller liquid fraction at the respective inlet. This is the case because, as a result of the expansion from the first pressure level to the second pressure level, part of the gases dissolved in the liquid of the three-phase component mixture outgas, and thereby increase the gas fraction or the proportion of the gas phase. On account of the lower liquid fraction, it is possible within the context of the present invention for an equal distribution of the multi-phase stream of the three-phase component mixture in one or more corresponding heat exchangers to be accomplished more easily. In this way, there is a decrease in the risk of local phase changes, and consequently the risk of increased local corrosion.

Since, as mentioned, the heat exchanger or exchangers used for the cooling from the second temperature level to the third temperature level is or are operated at the lower pressure level of the downstream systems, within the context of the present invention there is virtually no flash (outgassing) during the draining off of the liquid phase. Corresponding flash can be brought about centrally downstream of the heat exchanger or exchangers if the operating pressure of the heat exchanger or exchangers is close to the operating pressure of the downstream system. A second flash vessel or phase separator, which is used in conventional processes such as are illustrated in FIG. 1, can therefore be omitted.

Within the context of the present invention, there is also an advantageous process control that is not possible in the prior art. Such process control was previously not considered to be possible. According to the prior art, gas or vapour on the one hand and liquid and solids on the other hand are separated from one another at the same pressure level, for example in a separator, and the two streams forming are led away separately. Gas or vapour stream serves for controlling the pressure of the system and the liquid stream is led away directly. The small size of the liquid valve and solids valve in comparison with the gas or vapour valve means that it tends to block. In the present invention, on the other hand, all of the phases together flow through a suitable valve. By making it larger, the side-effects of blockages and deposits are minimized.

For further advantages that can be achieved by the process proposed according to the invention, reference is expressly made to the explanations above.

Advantageously, the expansion to the second pressure level is carried out by using a valve arrangement that has one or more expansion valves with in each case at least two flowed-through sealing edges and a maximum valve cross section of in each case at least 80%. In other words, within the context of the present invention, valves with at least two flowed-through sealing edges and at the same time the possibility of opening up almost the maximum free flow cross section are advantageously preferred as expansion valves. In particular, ball cocks or modified ball cocks with improved control characteristics can be used in this connection. The use of at least two sealing edges reduces the susceptibility to erosion, increases the service life of the valves and at the same time provides a good sealing capability. The possibility of opening almost 100% (this may for example be 80, 85, 90 or 95% opening or corresponding intermediate values) reduces the susceptibility to blockages due to the accumulation and deposition of particles or solids.

According to a particularly preferred configuration of the present invention, two or more expansion valves arranged in parallel may be used in a corresponding valve arrangement, allowing improved controllability of a corresponding installation and/or redundant operation with the possibility of carrying out maintenance without interrupting operation.

Advantageously, the first temperature level lies at 150 to 220° C., in particular at 185 to 210° C. The second temperature level, that is to say the temperature level that is achieved by the expansion from the first pressure level to the second pressure level, typically lies within the context of the present invention at 120 to 180° C., in particular at 150 to 175° C. and at the same time at least 5° C. below the first temperature level. As explained, by contrast with the prior art, a corresponding reduction of the temperature allows the loading of heat exchangers and other apparatuses in a device used according to the invention to be reduced significantly.

Within the context of the present invention, the third temperature level advantageously lies at ambient temperature up to 100° C., in particular below the boiling point of water. In this way, condensation of all the condensable components can be brought about, and consequently a technically complete phase separation can be ensured.

Advantageously, within the context of the present invention, the first pressure level lies at an absolute pressure of 10 to 15 bar, in particular from 30 to 40 bar, and the second pressure level lies at an absolute pressure of 1 to 10 bar, in particular of 4 to 7 bar.

Within the context of the present invention, it may be provided that a first fraction of the three-phase component mixture expanded to the second pressure level and cooled down to the second temperature level is subjected to a further cooling to the third temperature level and after that to the phase separation, and a second fraction thereof is subjected to the phase separation without the further cooling to the third temperature level. Such a measure allows the setting of a mixing temperature obtained from the temperatures of the first (further cooled) fraction and the second (not further cooled) fraction.

A corresponding measure may in particular also comprise furthermore a control of the temperature in that the first and second fractions are set in relation to one another in accordance with a temperature control.

In particular, in this connection, the further cooling of the first fraction may be carried out by using a heat exchanger unit comprising one or more heat exchangers, past which the second fraction is at least partially led. For example, within the context of the present invention, it is also possible to use a number of heat exchangers in series, which can be bypassed in part or as a whole in accordance with a temperature control by means of a bypass line.

Within the context of the present invention, the phase separation advantageously comprises the use of a phase separating unit, a gas phase and a two-phase component mixture, which comprises a liquid phase and solid particles, being formed in the phase separation. As explained, within the context of the present invention, the formation of the liquid phase thereby takes place without any significant further outgassing of dissolved gaseous components, so that it is possible to dispense with another phase separation. This applies in particular whenever the phase separating unit is operated at a pressure level of 1 to 10 bar absolute pressure, preferably between 4 and 7 bar absolute pressure. The pressure level of the phase separating unit may also lie at 1 to 2 bar absolute pressure.

Particular advantages can be achieved in the process according to the invention if a volume fraction of the gas phase in the three-phase component mixture lies at more than 25% and for example up to 75% or 50%. In this case, a particularly advantageous pressure control can be carried out in particular in connection with the measures explained below.

It is particularly advantageous if the three-phase component mixture is removed from the oxidation unit at a first geodetic height, is fed to the at least partial expansion from the first pressure level to the second pressure level at a second geodetic height, and is subjected to the cooling to the second temperature level at a third geodetic height, the second geodetic height lying below the first geodetic height and the third geodetic height lying below the second geodetic height. In other words, the outlet from the oxidation unit, that is to say from one or more oxidation reactors, represents a high point here. In particular, the oxidation unit or one or more oxidation reactors is or are in this case connected by one or more first lines to one or more expansion valves, which is or are used for the expansion from the first pressure level to the second pressure level, and the expansion valve or valves, which is or are used for the expansion from the first pressure level to the second pressure level, are connected by one or more second lines to the one or more heat exchangers, which is or are used for the further cooling to the third temperature level. The one or more first lines and the one or more second lines are in this case laid in particular in a steadily descending manner.

The present invention also extends to an installation for treating a waste lye of a lye scrub, with respect to which reference is made to the corresponding independent patent claim. Advantageously, a corresponding installation is set up for carrying out a process as explained above in various configurations, and has respectively corresponding means for this purpose. For features and advantages of an installation provided according to the invention, reference should therefore be made expressly to the above explanations of the process according to the invention and also the configurations thereof.

The invention is explained below in comparison with the prior art with reference to the appended drawings.

### BRIEF DESCRIPTION OF THE DRAWINGS

FIG. 1 illustrates in a simplified representation a process for treating a waste lye according to a configuration that is not according to the invention.

FIG. 2 illustrates in a simplified representation a process for treating a waste lye according to an embodiment of the invention.

### DETAILED DESCRIPTION OF THE DRAWINGS

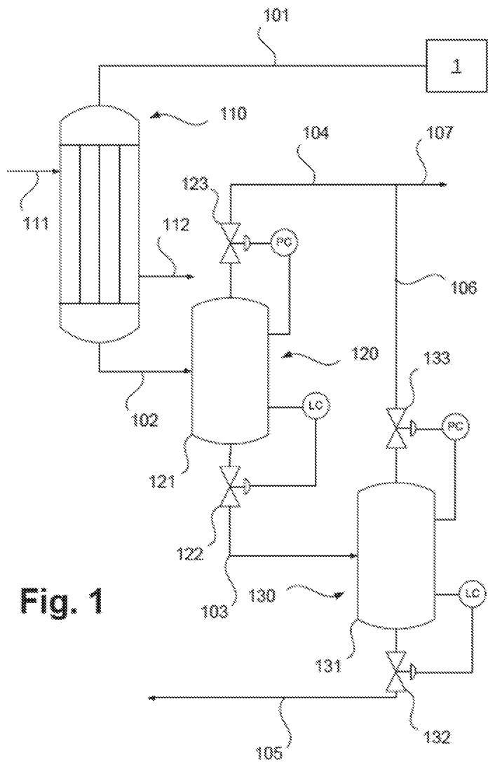

In FIG. 1, a process according to a configuration not according to the invention for treating a waste lye is illustrated in the form of a greatly simplified process flow diagram.

In the process illustrated in FIG. 1, a wet oxidation of a waste lye is performed by means of an oxidation unit 1, which is illustrated here in an extremely simplified manner and may comprise one or more oxidation reactors. For this purpose, the oxidation unit is fed waste lye together with steam and oxygen or an oxygen-containing gas mixture and this is subjected in the oxidation unit to a wet oxidation for a reaction time period at a first temperature level and a first pressure level. For the pressures and temperatures used here, reference should be made expressly to the explanations above.

In the process illustrated in FIG. 1, a three-phase component mixture, which is illustrated here in the form of a substance stream 101, is removed from the oxidation unit 1 and cooled down in a heat exchanger unit 110 at the pressure and temperature level at which it was removed from the oxidation unit 1. The heat exchanger unit 110 is in this case operated by using a temperature control medium, which is illustrated here in the form of a flow stream 111 and a return stream 112.

In the process illustrated in FIG. 1, a three-phase component mixture cooled down in this way is fed in the form of a substance stream 102 to a first phase separating unit 120, which comprises a vessel 121. In the vessel 121, a liquid phase with particles, that is to say a two-phase mixture, separates out at the bottom. By means of a valve 122, this can be drawn off in accordance with a filling level control LC in the form of a substance stream 103 and transferred into a second phase separating unit 130. This is required here because, during the expansion of the two-component mixture from the first phase separating unit, dissolved gases outgas (flash). In the second phase separating unit 130, which once again comprises a vessel 131, a two-phase component mixture therefore once again separates out at the bottom.

By means of a valve 123, a gas phase in the form of a stream 104 is drawn off in accordance with a pressure control PC from the top of the phase separating unit 120. This stream may be combined with a gas phase in the form of a substance stream 106 that is correspondingly drawn off by means of a valve 133 in accordance with a pressure control PC from the phase separating unit 130, to form a collective stream 107.

By the process according to the prior art that is illustrated in FIG. 1, finally a liquid stream with particles, that is to say a two-phase stream 105, can be provided by means of a valve 132 in accordance with filling level control LC from the second phase separating unit 130 and can for example be passed on for storage or further treatment.

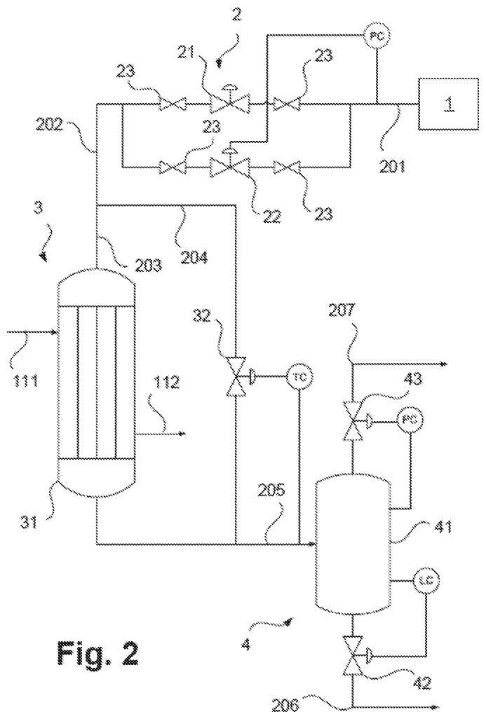

In FIG. 2, a process according to an embodiment of the present invention is illustrated in the form of a greatly simplified process flow diagram. Here, too, an oxidation unit 1 is used, with respect to which reference is made to the explanations relating to FIG. 1 and to the explanations given at the beginning.

A three-phase component mixture 201, which comprises a gas phase, a liquid phase and solid particles, is drawn off from the oxidation unit 1 at the pressure level at which the oxidation unit 1 is operated, and also at a corresponding temperature level. By contrast with the process illustrated in FIG. 1, however, it is then first expanded by means of an expansion unit 2. The expansion in this case takes place from a first pressure level to a second pressure level. For the pressure levels, reference is respectively made expressly to the explanations above. On the basis of the physical laws prevailing, the expansion results in a cooling of the three-phase component mixture 201 and a partial outgassing of dissolved gaseous components. A correspondingly formed, likewise three-phase component mixture is denoted by 202.

As is the case in the configuration of the present invention that is illustrated in FIG. 2, the expansion unit 2 may comprise here two expansion valves 21, 22 arranged in parallel, which may be formed in the way explained above. In this case, at least one of these expansion valves 21, 22 may be operated on the basis of a pressure control PC. Instead of a number of expansion valves 21, 22 being provided in parallel, however, valves may also be arranged in series or there may be a single valve. In the example represented, in particular switching valves 23 or shut-off valves are connected upstream or downstream of the expansion valves 21, 22.

In the embodiment of the present invention that is illustrated in FIG. 2, after it has been expanded from the first pressure level to the second pressure level in the expansion device 2, the three-phase component mixture 202 is divided into two partial streams 203 and 204. However, this is not absolutely necessary. It may also be merely that a treatment of the entire three-phase component mixture 202 in the manner of the substance stream 203 is provided. In such a case, the substance stream 204 is not formed.

In the example represented, the partial stream 203 is fed to a heat exchanger 31 in the heat exchanger unit 3, which, as already explained above with respect to the heat exchanger according to FIG. 1, may be flowed through by a refrigerant. This is represented here in the form of a flow 111 and a return 112, as illustrated in FIG. 1. However, on account of the different requirement for cold here, in particular a different refrigerant than in the process illustrated in FIG. 1 may be used. The three-phase component mixture 203 is cooled down further from the second temperature level to the third temperature level in the heat exchanger 31.

In parallel with this, in the embodiment illustrated in FIG. 2, optionally the partial stream 204 is led past the heat exchanger 31 by means of a valve 32 in accordance with a temperature control TC and is combined with the partial stream 203 cooled down there to form a collective stream 205. In this way, a temperature of the collective stream 205 can be set.

In the example represented, the collective stream 205 is fed into a phase separating unit 4, which has a vessel 41. This is provided with valves 42 and 43, which can be activated by means of a filling level control LC or a pressure control TC. By means of the phase separating unit 4 or the vessel 41, in this way a two-component mixture 206, which represents a liquid phase with particles, and a gas phase 207 can be formed.

By contrast with the embodiment according to the prior art that is illustrated in FIG. 1, according to this configuration of the invention the liquid phase 206 does not in this case have to be subjected to a further phase separation, since it has a smaller proportion of outgas components.

1. A process for treating a waste lye of a lye scrub in which the waste lye is fed with oxygen or an oxygen-containing gas mixture and steam to an oxidation unit (1) and in the latter is subjected to a wet oxidation for a reaction time period at a first temperature level and a first pressure level, a three-phase component mixture, which comprises a gas phase, a liquid phase and solid particles, being removed from the oxidation unit (1) and subjected to a cooling and phase separation, characterized in that at least part of the three-phase component mixture in an unchanged composition is first subjected to an expansion from the first pressure level to a second pressure level and thereby cooled down to a second temperature level, and in that the three-phase component mixture expanded to the second pressure level and cooled down to the second temperature level is subsequently subjected at least partly to a further cooling to a third temperature level and after that to a phase separation.

2. The process according to claim 1, in which the expansion to the second pressure level is carried out by using a valve arrangement (2) that has one or more expansion valves (21, 22) with in each case at least two flowed-through sealing edges and a maximum valve cross section of in each case at least 80%.

3. The process according to claim 2, in which expansion valves (21, 22) are formed as one or more ball valves.

4. The process according to claim 2, in which the valve arrangement (2) comprises two or more expansion valves (21, 22) arranged in parallel.

5. The process according to claim 1, in which the first temperature level lies at 180 to 220° C. and the second temperature level lies at 120 to 180° C. and at least 5° C. below the first temperature level.

6. The process according to claim 1, in which the third temperature level lies at ambient temperature up to 100° C.

7. The process according to claim 1, in which the first pressure level is at an absolute pressure of 20 to 50 bar and the second pressure level is at an absolute pressure of 1 to 10 bar.

8. The process according to claim 1, in which a first fraction of the three-phase component mixture expanded to the second pressure level and cooled down to the second temperature level is subjected to a further cooling to the third temperature level and after that to the phase separation, and a second fraction thereof is subjected to the phase separation without the further cooling to the third temperature level.

9. The process according to claim 8, in which the first and second fractions are set in relation to one another in accordance with a temperature control.

10. The process according to claim 8, in which the further cooling of the first fraction is carried out by using a heat exchanger unit (3) comprising one or more heat exchangers (31), past which the second fraction is at least partially led.

11. The process according to claim 1, in which the phase separation is carried out by using a phase separating unit (4) and in which a gas phase and a two-phase component mixture, which comprises a liquid phase and solid particles, are formed in the phase separation.

12. The process according to claim 11, in which the phase separating unit (4) is operated at a pressure level of 1 to 10 bar absolute pressure.

13. The process according to claim 1, in which the volume fraction of the gas phase in the three-phase component mixture lies at more than 25%.

14. The process according to claim 1, in which the three-phase component mixture is removed from the oxidation unit (1) at a first geodetic height, is fed to the at least partial expansion from the first pressure level to the second pressure level at a second geodetic height, and is subjected to the cooling to the second temperature level at a third geodetic height, the second geodetic height lying below the first geodetic height and the third geodetic height lying below the second geodetic height.

15. Installation for treating a waste lye of a lye scrub, with means which are set up for feeding the waste lye with oxygen or an oxygen-containing gas mixture and steam to an oxidation unit (1) and in the latter subjecting it to a wet oxidation for a reaction time period at a first temperature level and a first pressure level, and means which are set up for removing a three-phase component mixture, which comprises a gas phase, a liquid phase and solid particles, from the oxidation unit (1) and subjecting it to a cooling and phase separation, characterized in that means which are set up for first expanding at least part of the three-phase component mixture in an unchanged composition from the first pressure level to a second pressure level and thereby cooled down to a second temperature level are provided, and in that means which are set up for subsequently subjecting the three-phase component mixture expanded to the second pressure level and cooled down to the second temperature level at least partly to a further cooling to a third temperature level and after that to a phase separation are provided.
